(19) United States
(12) Patent Application Publication
(10) Pub. No.: US 2026/0277658 A1
(43) Pub. Date: Sep. 17, 2026

(54) Method, A System and A Cloud Platform For Migrating Virtual Machines

(71) Applicant: Trianz Digital Consulting Private Limited, Bangalore South (IN)

(72) Inventors: Anil Kumar Gupta, Bangalore South (IN); Kalpana Mandloi, Bangalore South (IN); K Niyaz Ahmed, Bangalore South (IN); Merugumala Sai Krishna, Bangalore South (IN); Ravi Kumar Bharadwaj, Bangalore South (IN)

(73) Assignee: Trianz Digital Consulting Private Limited, Bangalore South (IN)

(21) Appl. No.: 19/668,949

(22) Filed: May 6, 2026

(30) Foreign Application Priority Data
May 29, 2025 (IN) 202541051467

(51) Int. Cl. G06F 9/455; G06F 21/64

(52) U.S. Cl. CPC G06F 9/45558; G06F 21/64; G06F 2009/45583; G06F 2009/45587; G06F 2009/45595

(57) ABSTRACT

The present invention provides a method (200), a system (300), and a cloud platform (400) for migrating VMs (501a) from a source host (520) to a target environment (530). The system (300) and the cloud platform (400) include an extractor (310, 410) to extract OS data (O1) of the VM (501a), a migration tool (320, 420) to transfer and store extracted data (550a), a configurator (330, 430) to provision VMs (502a), and a synchronizer (340, 440) for synchronizing the provisioned VM (502a) and the stored data (203) for migrating the VM (501a) to the target environment (530) as the VM (522a). The present invention enhances security, ensures seamless operation and data integrity, and leverages SaaS for scalability and efficient resource use.

### CROSS REFERENCE TO RELATED APPLICATIONS

Benefit is claimed to Indian Patent Application No. IN20254105146, filed on May 29, 2025, the contents of which are incorporated by reference in their entirety.

### FIELD OF THE INVENTION

The present invention relates to migration of virtual machines from on-premises computing environments to cloud environments. More specifically, the invention relates to a method, system, and cloud platform for migrating virtual machines from on-premises environments or between cloud environments.

### BACKGROUND

A virtual machine (VM) is a software emulation of a physical computer, running its own operating system and applications independently. VMs use the host system's hardware resources while remaining isolated from other VMs. This allows multiple VMs to run on a single physical machine, enhancing resource utilization and security. VMs are essential in cloud computing and development environments.

A source host is the original computing environment where a virtual machine resides. This includes an on-premises server or a cloud-based server. The target environment is the destination computing environment to which the virtual machine is being migrated, typically a cloud-based server. The migration process involves transferring the virtual machine's data from the source host to the target environment to ensure seamless operations in a new environment.

Migration of virtual machines (VMs) involves transferring VMs from one host (source) to another (target), typically to optimize performance or resources. Prior art methods include live migration, where VMs are moved without downtime; Cold migration, involving VM shutdown before transfer (migration); and Storage migration, which moves VM data to different storage devices. These methods ensure minimal disruption and efficient resource utilization during the migration process.

Agentless migration refers to the process of migrating virtual machines without installing persistent software agents or hypervisor plugins on a source host. The extraction process may utilize temporary tools that are invoked during the extraction phase but do not require permanent installation or hypervisor-level access.

Current methods for migrating virtual machines often rely on hypervisor-based migration, which involves creating a hypervisor layer to facilitate the transfer. However, these methods face limitations as they are not universally compatible with all cloud platforms, leading to issues with adaptability and agility. Additionally, hypervisor-based migrations require the source host to grant full access to its IT infrastructure to the migrator, posing security and operational challenges. For example, if a user intends to migrate VMs from an on-premises server to a cloud environment, the hypervisor-based approach may not work seamlessly across different cloud providers like AWS or Azure. Moreover, the need for complete access to the source host's infrastructure can expose sensitive data and complicate the migration process.

US10216531B2 describes a method for shifting virtual machines between different hosts within a cloud environment. The method involves extracting the virtual machine data, transferring VM to the target environment, and provisioning the virtual machine on the target environment. The method uses hypervisor layers of VMs for migration.

CN114356450A describes a cross-cloud migration deployment method and system. The method uses constructing project engineering, loading scene components, and configuring service protocols to facilitate the migration of virtual machines across different cloud environments. The method uses hypervisor layers of VMs for migration.

WO2020/019017A1 describes a method for migrating virtual machines within a cloud environment. It includes steps for extracting virtual machine data, transferring it to the target environment, and provisioning the virtual machine on the target environment. The method ensures synchronization of the virtual machine with the stored data to enable its functioning in the new environment. This method also uses hypervisor of VM for migration.

One major challenge in hypervisor-based methods of the patents described above is ensuring that the destination host has sufficient resources to accommodate the VM being migrated. This includes adequate CPU, RAM, and storage. If the destination host lacks these resources, the migration process can fail, leading to downtime and potential data loss. Proper planning and resource assessment are crucial to avoid such issues.

Another significant problem is network connectivity between the source and destination hosts. Slow or unstable network connections can disrupt the migration process, causing delays or failures. Ensuring a stable and high-speed network connection is essential for a smooth migration. Network configuration and bandwidth must be carefully managed to prevent interruptions during the transfer of VM data. If there are variations in these factors, there is loss of data while migration.

Therefore, there is a need for a more flexible and secure migration methods that can overcome these limitations and ensure smooth transitions between diverse environments

An object of the present invention is to provide a system, a method, and a cloud platform for migrating virtual machines.

Another object of the present invention is to enhance data security by providing granular access control, while migrating the virtual machines from a source host to a target environment.

Another object of the present invention is to provide a method, a system, and a cloud platform for migrating VMs with improved agility to adapt to diverse types of computing platforms.

Another object of the invention is to provide a method for migration which reduces loss of data while migration

### SUMMARY

The present invention addresses the challenges associated with migrating virtual machines (VMs) from on-premises environments or cloud to cloud platforms (environments). Traditional hypervisor-based migration methods face compatibility issues across different cloud providers and require full access to the source host's infrastructure, posing security risks. Additionally, these methods struggle with resource allocation and network connectivity, leading to potential downtime and data loss. The invention aims to provide a more flexible, secure, and efficient migration process that overcomes these limitations.

The invention provides a method, a system, and a cloud platform for migrating VMs. The method, the system and the cloud platform use an extractor for retrieving the operating system data from the source VM, a migration tool for transferring said data to the target environment, a configurator for provisioning a new VM in the target environment, and a synchronizer for ensuring the new VM operates seamlessly with the transferred data. The system and the cloud platform can also include a buffer memory for temporary storage during the migration process and implemented as SaaS applications for enhanced scalability and flexibility.

The method for migrating virtual machines involves several steps of selecting the VM to be migrated, extracting the operating system data, transferring the extracted data to the target environment, provisioning a new VM in the target environment, and synchronizing the provisioned VM with the stored data. The method starts with selecting the VM through a user interface or a machine learning (ML) module. The extractor then retrieves the operating system data, which is to be transferred to the target environment using the migration tool. The configurator sets up the new VM with the necessary virtual hardware components, and the synchronizer ensures that the new VM operates correctly by synchronizing it with the stored data. This method ensures a smooth and secure migration process, minimizing downtime and data loss.

The system for migrating virtual machines includes several key elements such as an extractor, a migration tool, a configurator, and a synchronizer. The extractor is responsible for retrieving the operating system data from the source VM, ensuring that all necessary information is captured for the migration. The migration tool facilitates the transfer of this extracted data to the target environment. The migration tool uses techniques that do not rely on hypervisor APIs. The configurator provides a new VM in the target environment based on the extracted data, setting up virtual hardware components such as CPUs, memory, network adapters, and storage. Finally, the synchronizer ensures that the provisioned VM operates seamlessly by synchronizing it with the stored data, maintaining consistency and performance.

The present invention enhances security by transferring only necessary data, reducing the need for full access to the source host's infrastructure. The present invention ensures compatibility across various cloud platforms.

### BRIEF DESCRIPTION OF DRAWINGS

FIG. 1A shows a flowchart of a method for migrating VMs in accordance with the present invention;

FIG. 1B shows a flowchart of another embodiment of a method for migrating VMs in accordance with the present invention;

FIG. 2A shows a schematic diagram of a source host and a target environment where the method shown in FIG. 1A is executed and a system for migration in accordance with the present invention;

FIG. 2B shows a schematic diagram of a source host and a target environment where the method shown in FIG. 1B is executed;

FIG. 3 shows a schematic diagram of alternative embodiments of the system shown in FIG. 2A; and

FIG. 4 shows a schematic diagram of a cloud platform for migrating VMs in accordance with the present invention.

### DETAILED DESCRIPTION OF THE INVENTION

The present invention provides a method (200), a system (300), and a cloud platform (400) for migrating virtual machines (VMs) from a source host (520) to a target environment (530). Using the method (200), the system (300) and the cloud platform (400), a user can migrate the virtual machines (VMs) from the source host (520) to the target environment (530).

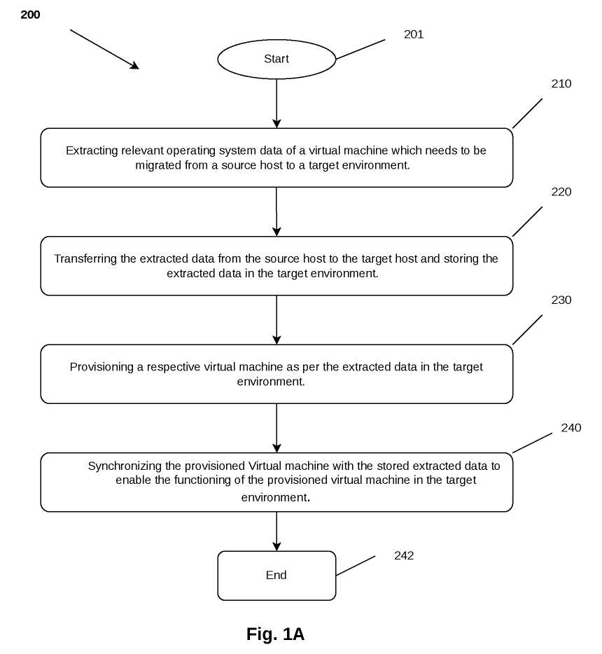

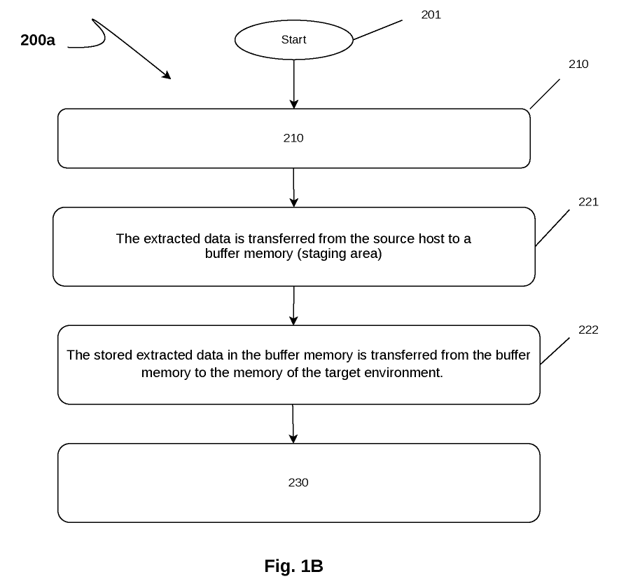

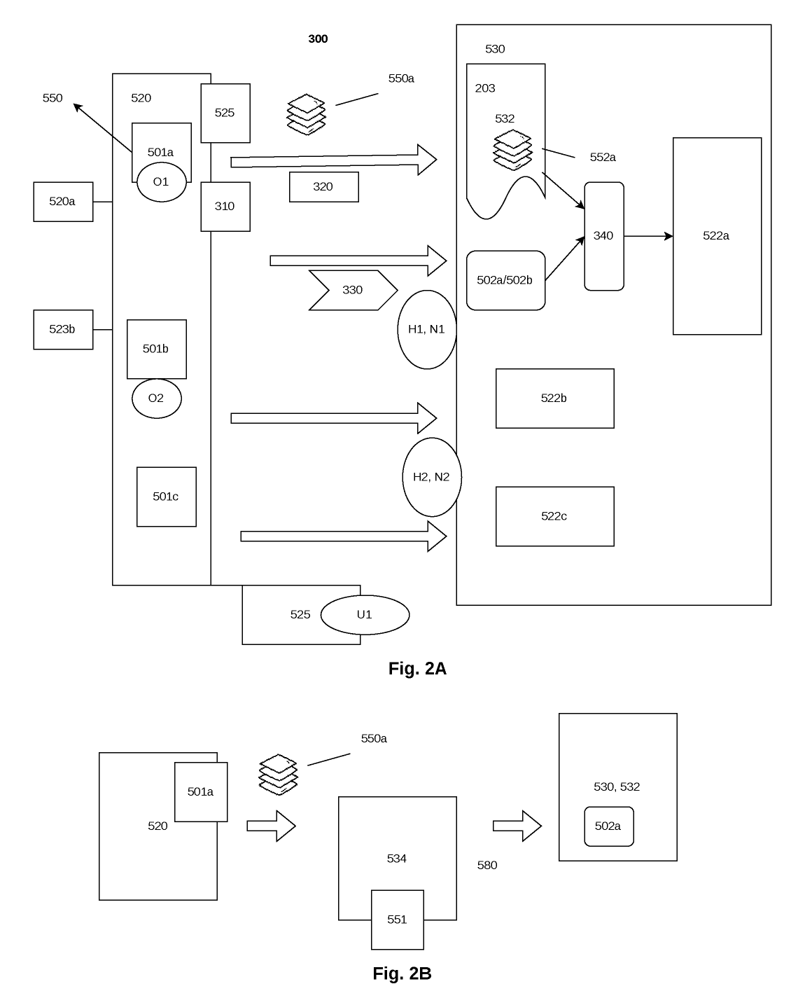

In a preferred embodiment of the invention, the method (200) (FIG. 1A) for migrating the VMs is provided. The method (200) migrates a virtual machine(s) (501a/501b/501c) (FIG. 2A) from the source host (520) to the target environment (530). The source host (520) includes an on-premises computing environment (520a) or a cloud environment (523b). The on-premises computing environment (520a) includes physical servers hosting applications and databases, networking equipment like routers and switches, and storage systems such as hard drives and SSDs. The cloud environment (523b) can include virtual servers that provide scalable computing resources. The cloud environment (523b) includes various storage solutions such as object storage, block storage, and file storage, networking services like virtual networks, load balancers, and firewalls managing traffic and security; includes managed database services.

Additionally, the cloud environment (523b) includes security services like identity and access management, encryption, and threat detection, all managed by cloud service providers. The cloud environment (523b) includes a cloud platform. Trade names of some existing cloud platforms include Amazon Web Services (AWS), Microsoft Azure, Google Cloud Platform (GCP), IBM Cloud, and Oracle Cloud.

The target environment (530) is a cloud environment. The virtual machines (501a, 501b, 501c) are running on the source host (520). The target environment (530) is preferably a cloud environment or another computing environment or a cloud platform.

The method (200) starts at step (201).

The selected virtual machine (501a/501b) is migrated from the source host (520) to the target environment (530). More specifically, the required virtual machine (VM) (501a) is selected through a user interface (U1) of a computing device (525) by a user, or the selection is made automatically through a preprogrammed selection module.

At step 210, the data (550) of the selected virtual machine (501a) is extracted. More specifically, the data (550) is the data of an operating system (O1/O2) of the virtual machine (501a). The data (550) includes one or more operating systems (O1, O2) which are responsible for the operations of the virtual machine (501a). The computing device (525), the source host (520) is configured with an extractor (310). The extractor (310) has a set of prestored modules (instructions) to extract operating system (O1) data from the virtual machine (VM) (501a) by accessing the VM's virtual disk files, such as VMDK (Virtual Machine Disk) files. The disk files store all the data of the VM, including the operating system, applications, and user files. The extractor (310) mounts the VMDK file to another working VM or disk extraction utilities to open and extract the data. This process ensures that the operating system data is accurately retrieved without booting the original VM. The extractor (310) may use such techniques to extract data from the operating system (O1) of the virtual machine (501a). If the VM (501b) is selected to migrate, the extractor (310) extracts the operating system (O2) of the VM (501b). The data (550) with the Operating system (O1/O2) details forms an extracted data (550a).

The extractor (310) bypasses the hypervisor layer entirely and directly accesses the virtual disk files of the virtual machine (501a) at the operating system (O1) level. The extractor (310) attaches the VMDK file of the virtual machine (501a) as a network block device without invoking any hypervisor APIs, then mounts the OS partition in read-only mode to extract system files, registry hives, boot configuration data, and installed application metadata from the operating system (O1). The extractor (310) reads only the specific virtual disk file associated with the selected virtual machine (501a) on the source host (520) and does not require administrative privileges over the hypervisor, other virtual machines (501b, 501c), or the host infrastructure. The extracted operating system (O1) data including partition structure, system configurations, and boot records forms the extracted data (550a). This ensures that the extraction performed by the extractor (310) is hypervisor-agnostic and operates purely at the operating system (O1) data level of the virtual machine (501a).

In some embodiments, While the extraction process operates at the operating system level and does not require hypervisor-level access, the implementation may utilize disk-access utilities compatible with different virtualization formats while remaining independent of hypervisor control layers or appropriate tools for Microsoft Hyper-V environments (VHD/VHDX files), and KVM/QEMU environments (QCOW2/raw image files) for maximum compatibility across diverse hypervisor platforms.

When the source host (520) is a cloud environment (523b), the extractor (310) accesses the virtual disk file of the virtual machine (501a) through the cloud provider's storage API to download or mount the disk image to a local or temporary compute instance. Once the virtual disk file is accessible, the extractor (310) proceeds with the same OS-level extraction process as described for the on-premises computing environment (520a), mounting the disk image in read-only mode and extracting the operating system (O1) partition data including system files, registry hives, and boot configuration to form the extracted data (550a). The extractor (310) does not require access to the hypervisor management plane of the cloud environment (523b) and operates solely on the downloaded or mounted virtual disk file of the virtual machine (501a). This ensures the extraction performed by the extractor (310) remains hypervisor-agnostic regardless of whether the source host (520) is the on-premises computing environment (520a) or the cloud environment (523b).

The migration tool (320) transfers the extracted data (550a) from the source host (520) to the target environment (530) as a data package over standard network transfer protocols such as HTTPS or SFTP. The migration tool (320) does not perform hypervisor-level VM migration and operates independently of tools. The extracted data (550a) containing the operating system (O1) data is transmitted by the migration tool (320) as a structured data package to the memory (532) of the target environment (530), where the transferred data (552a) is stored as the stored data (203). The activity of the migration tool (320) is triggered by a user through the user interface (U1) of the computing device (525).

The migration tool transmits the extracted data as a structured data package over standard network protocols without performing hypervisor-based virtual machine migration.

At step 220, the extracted data (550a) from the source host (520) is transferred to the target environment (530) by a migration tool (320). The migration tool (320) transfers the extracted operating system data as a structured data package without transferring hypervisor state or virtual machine runtime memory. Alternatively, a user can opt for cold migration techniques, where the VM is powered off before the transfer, ensuring no active processes are disrupted. The activity of the migration tool (320) is triggered by a user through the user interface (U1). The extracted data (550a) after transferred to the target environment (530) forms a transferred data (552a). Further, the transferred data (552a) is stored in a memory (532) of the target environment (530). The transferred data (552a) stored in the memory (532) is a stored data (203).

The transferred data (552a) is the extracted data (550a) after it has been transmitted to and received by the target environment (530). Once stored in the memory (532) of the target environment (530), the transferred data (552a) becomes the stored data (203), representing the complete operating system (O1/O2) data of the source virtual machine (501a/501b) ready for provisioning.

At step 230, a selected virtual machine (502a) as per the extracted data (550a) is provisioned in the target environment (530). A selected virtual machine (502a) is the VM having corresponding functions and configurations of the Virtual machine (501a) which is intended to migrate from the source host (520) to the target environment (530). The virtual machine (502a) is the VM at the target environment (530). A virtual machine (502b) is configured at the target environment (530) for migrating the virtual machine (501b) from the source host (520) to the target environment (530).

More specifically, provisioning is done by a configurator (330). The configurator (330) is a sub module, or a module configured in the target environment (530). The configurator (330) may clone the VM (501a), deploying from a template, or creating from a blank virtual hard disk for provisioning the VM (502a). The provisioning process includes setting up a virtual hardware (H1, H2) according to the extracted data (550a). Setting up virtual hardware (H1) during the provisioning of a virtual machine (502a) involves configuring various components to ensure the VM (502a) operates effectively. Further, allocating virtual CPUs (vCPUs), which determines the processing power available to the VM (502a), and assigning virtual memory (RAM) to provide the necessary resources for applications and the operating system. Additionally, virtual network adapters (vNICs) are configured to enable network connectivity, allowing the VM (502a) to communicate with other devices and the networks (N1). Furthermore, storage is set up by attaching virtual hard disks (VHDs) or virtual machine Disk files (VMDKs), which stores the VM's data and operating system (O1).

Virtual hardware, referred to as hardware configuration (H1) for a first virtual machine and hardware configuration (H2) for a subsequent virtual machine, includes the virtual CPU (vCPU) count, virtual memory (RAM) allocation, virtual network adapters (vNICs), virtual hard disks (VHDs) or virtual machine disk files (VMDKs), and optional components such as virtual graphics adapters, USB controllers, and peripheral device mappings.

The virtual network adapters (vNICs) are connected to virtual networks (N1 for the source host (520) and N2 for the target environment (530)) to enable network connectivity and communication between the migrated virtual machine (502a) and other systems.

Other settings, such as virtual graphics adapters and peripheral devices, can also be configured based on the VM's (502a) requirements. This setup ensures the VM (502a) has all the necessary virtual hardware components to function as a physical machine.

The provisioning process involves installing necessary software, and configuring networks (N1, N2) settings according to the virtual hardware.

The user interface (U1) may have a set of modules to enable the user to perform the provisioning of the VM (502a) in the target environment (530).

At step 240, the provisioned virtual machine (502a) in the target environment (530) is synchronized with the stored data (203) to enable the functioning of the provisioned virtual machine (502a) in the target environment (530). A synchronizer (340) is associated with the target environment (530). The synchronizer (340) is a sub module with configured instructions. The synchronizer (340) synchronizes the provisioned virtual machine (502a) in the target environment (530) with the stored data (203).

The synchronizer (340) compares contents of a source virtual disk with a target virtual disk. The comparison identifies any differences between the two disks, ensuring that the target VM (502a) has an exact replica of the source VM's (501a) data (550).

The synchronizer (340) tracks changes to the VM's (502a) data and replicates these changes to the target environment (530). The synchronizer (340) performs the delta synchronization operation, where only the changes made to the VM's (502a) data since the last synchronization are replicated. This ensures that the target VM (502a) remains up to date with minimal data transfer.

The synchronizer (340) performs delta synchronization as follows: (1) Maintain a database or hash table of SHA-256 hashes computed from the last full synchronization; (2) During the current synchronization cycle, compute SHA-256 hashes for the same corresponding blocks on the provisioned virtual machine's (502a) disk; (3) Compare current hashes against stored hashes to identify differing blocks (delta blocks); (4) Transfer only the delta blocks from the stored data (203) to the provisioned VM's disk at their corresponding offsets; (5) Update the hash database with new hashes for the transferred blocks; (6) Repeat steps 2-5 for each synchronization cycle until all blocks match or maximum synchronization time is reached.

The synchronizer (340) operates on the stored data (203) in the memory (532) of the target environment (530) and the provisioned virtual machine's (502a) virtual disk without relying on any hypervisor-based replication mechanism such as Changed Block Tracking (CBT). The synchronizer (340) divides both the stored data (203) and the provisioned virtual machine's (502a) disk into fixed-size blocks of 4 MB each, computes a SHA-256 hash for each corresponding block pair, and compares the hashes. For every block pair where the hashes differ, the synchronizer (340) copies the source block from the stored data (203) to the corresponding offset on the provisioned virtual machine's (502a) disk. After all differing blocks are transferred, the synchronizer (340) performs a full-disk checksum validation to confirm that the provisioned virtual machine's (502a) disk is a complete and exact replica of the stored data (203) containing the operating system (O1) data. If any block fails validation, the synchronizer (340) re-copies only the failed blocks and repeats validation up to a configurable retry limit, after which the synchronizer (340) reports failure to the user interface (U1), ensuring the provisioned virtual machine (502a) boots and operates with the complete operating system (O1) environment as the migrated VM (522a).

The synchronizer (340) does not rely on hypervisor-based replication mechanisms such as Changed Block Tracking (CBT) because CBT requires active hypervisor-level APIs and cannot operate on operating system data that has been extracted at the OS level. Instead, the block-level SHA-256 hash comparison provides equivalent change detection without hypervisor dependencies.

The retry limit is configurable via the user interface (U1), with a default value of 3 retries. Users can adjust this value in the system settings of the source host (520) or target environment (530). If the retry limit is exceeded, the synchronizer (340) halts synchronization and generates an error message indicating which blocks failed validation and their physical disk locations.

The 4 MB block size is selected to balance synchronization efficiency with network bandwidth utilization. Blocks smaller than 4 MB increase hash computation overhead, while blocks larger than 4 MB reduce granularity and increase retransmission burden if a single block fails validation. This size is particularly effective for typical VM disk configurations ranging from 50 GB to 2 TB.

Hardware elements involved in synchronization include the target environment's (530) storage systems (532), such as SSDs (Solid State Drive) or HDDs (Hard Disk Drive), which store the VM's (502a) data. Network adapters and controllers manage the data transfer between the source and target environments, ensuring efficient and secure communication. Additionally, the target environment's (530) CPU and memory resources are allocated to the VM (502a) to manage the synchronization tasks and maintain performance.

The synchronizer (340) schedules replication based on factors like data change rates and network bandwidth. The replication agent tracks changes to the VM's virtual disks and periodically sends these changes to the target environment. This process ensures that the target VM's data is continuously updated, maintaining consistency with the source VM.

After the step of synchronization (240), the VM (501a) is migrated from the source host (520) to the target environment (530) as the VM (522a). The synchronization (240) involves a combination of software and hardware elements working together to ensure the VM operates correctly and efficiently in the target environment (530). This process minimizes downtime and ensures data integrity, providing a seamless transition for the VM (502a) from the source host (520) to the target environment (530).

The user interface (U1) may have a set of modules to enable the user to perform the synchronization (240).

All the data related to the VM (501a) is transferred to the target environment (530) and the VM (522a) runs in the target environment (530) with all the data carried from the source host (520). The user may use the VM (522a) in the target environment (530) for computing operations. The method (200) ends at step 242.

By following the steps of the method (200), the VM (501b) is migrated from the source host (520) to the target environment (530) as the (522b) (by provisioning the hardware (H2) and the network (N2)). The VMs (501a, 501b, 501c) are migrated from the source host (520) to the target environment (530) as VMs (522a, 522b, 522c) using the method (200). The VMs are migrated one after the other or subsequently or in parallel.

In a first example, the virtual machine (501a) running Windows Server (Trade name) on the source host (520) being an on-premises computing environment (520a) is migrated to the target environment (530) being a cloud environment. The extractor (310) mounts the VMDK file of the virtual machine (501a), extracts the operating system (O1) partition including system registry and boot files to form the extracted data (550a), and the migration tool (320) transfers the extracted data (550a) to the memory (532) of the target environment (530) as the stored data (203). The configurator (330) provisions the selected virtual machine (502a) with matching virtual hardware (H1) specifications including vCPUs, virtual memory, and virtual network adapters (vNICs), and the synchronizer (340) synchronizes the provisioned virtual machine (502a) with the stored data (203) using block-level checksum validation to ensure the virtual machine (502a) functions in the target environment (530) as the migrated VM (522a). Throughout this process, the extractor (310) accesses only the virtual disk file of the virtual machine (501a) and does not interface with the hypervisor layer of the source host (520).

In one more embodiment (200a) (FIG. 1B) of the method (200), there are two additional steps 221, and 222 for transferring the extracted data (550a).

At step 221, the extracted data (550a) is transferred from the source host (520) to a buffer memory (534) (FIG. 2B) (also referred as “staging area”). The extracted data (550a) is stored in the buffer memory (534). The buffer memory (534) is a memory of a computing environment (580) which is functionally connected to the source host (520) and the target environment (530).The buffer memory (534) is located in an intermediate computing environment (580), which is functionally connected to both the source host (520) and the target environment (530).

At step 222, the stored extracted data (551) in the buffer memory (534) is transferred from the buffer memory (534) to the memory (532) of the target environment (530).

The buffer memory (534) serves as a hypervisor-independent intermediate storage area that holds the extracted data (550a) containing the operating system (O1) data before the extracted data (550a) reaches the memory (532) of the target environment (530). During transfer of the extracted data (550a) from the source host (520) to the buffer memory (534) at step (221), a SHA-256 checksum is computed for each data block of the extracted data (550a) and recorded in a manifest file stored alongside the extracted data (550a) in the buffer memory (534). In case a network interruption occurs during step (221), the migration tool (320) reads the manifest to identify successfully stored blocks and resumes transfer from the last incomplete block, ensuring no retransmission of already-stored portions of the extracted data (550a). Upon completion, the buffer memory (534) validates the stored extracted data (551) against the manifest before the migration tool (320) initiates step (222) to transfer the stored extracted data (551) from the buffer memory (534) to the memory (532) of the target environment (530). Because the buffer memory (534) stores only the extracted operating system (O1) data and not hypervisor state or full VM snapshots, the buffer memory (534) requires significantly less storage capacity and eliminates dependency on hypervisor-specific snapshot mechanisms.

In this alternative embodiment (200a), step 221 and step 222 replace step 220. The extracted data (550a) does not directly transfer to the target environment (530) memory (532) but instead passes through the buffer memory (534) first. In one more embodiment of the present invention (FIG. 2A), the system (300) for migrating VMs (501a, 501b, 501c, 501c) is provided. The system (300) has modules such as the extractor (310), the migration tool (320), the configurator (330), and the synchronizer (340). The system (300) relates to the method (200) described above. The system (300) is configured in a computing environment with the source host (520) and the target environment (530).

The extractor (310) of the system (300) is associated with the source host (520) for extracting the data (550) which is the data of the operating system (O1/O2) of the virtual machine (501aor 501b). The data (550) is migrated from the source host (520) to the target environment (530). The migration tool (320) of the system (300) is associated with the source host (520) for transferring the extracted data (550a) from the source host (520) to the target environment (530).

The configurator (330) of the system (300) is associated with the target environment (530) for provisioning the selected virtual machine (502a) according to the extracted data (550a) in the target environment (530). The synchronizer (340) of the system (300) is associated with the target environment (530) for synchronizing the provisioned virtual machine (502a) in the target environment (530) with the stored data (203) to enable the functioning of the provisioned virtual machine (502a) in the target environment (530).

The modules (310, 320, 330, 340) are configured separately in selected memories of the source host (520) and the target environment (530).

A user can configure these modules in the existing source host (520) and the target environment (530) to migrate the virtual machines (501a, 501b).

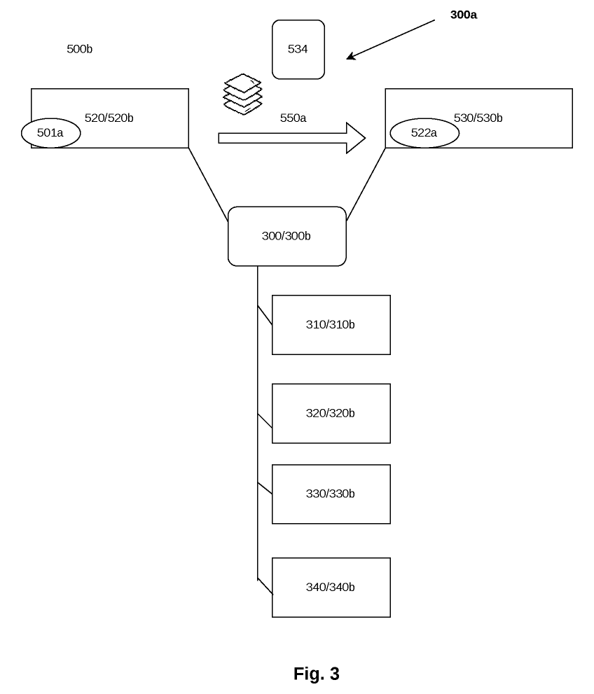

In one more embodiment (300a) (FIG. 3) of the system (300), the system (300a) has the buffer memory (534). The extracted data (550a) from the source host (520) is stored in the buffer memory (534) (FIG. 2B) of the system (300a) before transferring to the memory (532) of the target environment (530).

In one more embodiment (300b) (FIG. 3) of the system (300), the system (300b) has an extractor (310b), a migration tool (320b), a configurator (330b), and a synchronizer (340b). The extractor (310b), the migration tool (320b), the configurator (330b), and the synchronizer (340b) are SaaS applications. The source host (520b) and the target environment (530b) are connected to a SaaS infrastructure (500b). The SaaS infrastructure (500b) has a set of hardware and software for enabling the SaaS applications to perform selected functions as SaaS services. The functions, configurations of the extractor (310b), the migration tool (320b), the configurator (330b), and the synchronizer (340b) are same as of the functions, configurations of the extractor (310), the migration tool (320), the configurator (330), and the synchronizer (340). The extractor (310b), the migration tool (320b), the configurator (330b), the synchronizer (340b) has SaaS supportive applications which enable the SaaS based functioning of the extractor (310b), the migration tool (320b), the configurator (330b), and the synchronizer (340b).

In the SaaS embodiment (500b), the extractor (310b), the migration tool (320b), the configurator (330b), and the synchronizer (340b) are deployed as containerized microservices on the SaaS infrastructure (500b). Each of the extractor (310b), the migration tool (320b), the configurator (330b), and the synchronizer (340b) exposes RESTful API endpoints over HTTPS with OAuth 2.0 authentication, and the extractor (310b) receives only the path to the virtual disk file of the selected virtual machine (501a) on the source host (520b) without requiring any hypervisor-level credentials or host administrative access. A central SaaS orchestration layer within the SaaS infrastructure (500b) manages multi-tenant isolation by assigning unique tenant identifiers to each migration session, ensuring that the extracted data (550a) of one tenant remains inaccessible to others. The source host (520b) connects to the SaaS infrastructure (500b) through a lightweight connector agent that establishes an outbound TLS tunnel, accesses the virtual disk file of the virtual machine (501a) locally, and streams the operating system (O1) data to the extractor (310b) without exposing the hypervisor management plane or other virtual machines (501b, 501c) on the source host (520b). The SaaS infrastructure (500b) enables centralized updates and horizontal scaling of the extractor (310b), the migration tool (320b), the configurator (330b), and the synchronizer (340b) while preserving OS-level-only data access throughout the migration process.

In the SaaS embodiment, the extractor (310b) receives only a secure file path reference to the virtual disk file on source host (520b) and an OAuth 2.0 access token, never storing or caching the virtual disk file content. The migration tool (320b) streams the extracted operating system data using TLS 1.2 or higher encryption. The configurator (330b) provisions virtual machines in the target environment (530) using the cloud provider's native APIs without storing configuration credentials in the system database. The synchronizer (340b) validates all block hashes against a cryptographic signature before writing to the target virtual machine (502a) disk, ensuring data integrity and preventing man-in-the-middle attacks. Multi-tenant isolation is enforced by the SaaS infrastructure (500b) which prefixes all data keys with the tenant identifier (e.g., 'tenant-123-data-550a') and restricts database queries to the current tenant's identifier.

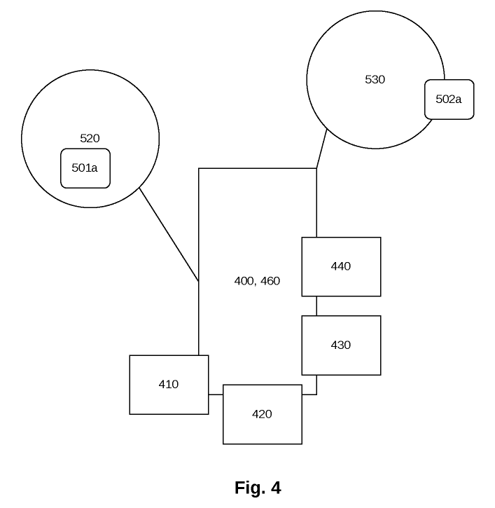

In one more embodiment of the present invention a cloud platform (400) (FIG. 4) for migrating the virtual machine(s) (501a, 502a, 502c) from the source host (520) to the target environment (530) is provided. The cloud platform (400) is connected functionally to the source host (520) and the target environment (530) through networks. The cloud platform (400) is accessed via a URL or by activating an application configured in a computing device (460). The computing device (460) is functionally connected to the source host (520) and the target environment (530).

The cloud platform (400) has the modules which are configured in a memory of the cloud platform (400). The modules are an extractor (410), a migration tool (420), a configurator (430), and a synchronizer (440). The extractor (410) is associated with the source host (520) connected with the cloud platform (400). The extractor (410) extracts the data (550) of the virtual machine (501a/501b) to be migrated from the source host (520) of the cloud platform (400) to the target environment (530) of the cloud platform (400). The data (550) is the data of an operating system (O1, O2) of the virtual machine (501a or 501b) in the cloud environment.

The migration tool (420) of the cloud platform (400) is associated with the source host (520) for transferring the extracted data (550a) from the source host (520) to the target environment (530). The extracted data (550a) is stored in the memory (532) of the target environment (530).

The configurator (430) is associated with the target environment (530) for provisioning the selected virtual machine (502a) according to the extracted data (550a) in the target environment (530).

The synchronizer (440) is associated with the target environment (530) for synchronizing the provisioned virtual machine (502a) in the target environment (530) with the stored data (203) to enable the functioning of the provisioned virtual machine (502a) in the target environment (530).

The functions, configurations of the extractor (410), the migration tool (420), the configurator (430), and the synchronizer (440) of the cloud platform (400) are same as of the functions, configurations of the extractor (310), the migration tool (320), the configurator (330) and the synchronizer (340) of the system (300).

By using the method (200), the virtual machine (501a) transferred (migrated) from the source host (520) to the target environment (530) as the VM (522a).

If a user needs to transfer VMs by storing the VMs in the staging area, the user can opt for the method (200a).

By using the system (300), the virtual machine (501a/501b) is transferred (migrated) from the source host (520) to the target environment (530) as the VM (522a, 522b).

If a user needs to store the extracted data (550a) in a staging area (buffer memory (534), the user may configure the system (300a) in the source host (520) and the target environment (530).

If a user needs to transfer the VMs as SaaS operations, the user can opt for the system (300b).

If a user needs a cloud platform for migration of the VMs (501a, 501b) from the source host (520) to the target environment (530), the user can opt for the cloud platform (400) which is functionally connected to the source host (520) and the target environment (530) for migrating the VMs.

The present invention (200, 300, 400) extracts the operating system (O1, O2) data of the virtual machine (501a, 501b), ensuring compatibility across different cloud platforms, thereby improving agility to adapt to distinct types of computing platforms. The present invention (200, 300, 400) enhances security by transferring only the necessary data to the target environment (530), reducing the need for full access to the source host's (520) infrastructure. Therefore, the present invention improves granularity of access, while migrating the virtual machines from a source host (520) to a target environment (530). Finally, provisioning (230) and synchronizing (240) the virtual machine (522a) in the target environment (530) ensures seamless operation without exposing sensitive data and without any data loss.

The present invention (200a, 300a) has an advantage of enhancing data integrity and reliability by providing a temporary storage area (buffer memory (534)) that can manage data inconsistencies and network interruptions, ensuring a smoother and more secure migration process.

An additional advantage of the present invention (300b) is enhanced scalability and flexibility, allowing for easier updates and maintenance of migration tools by the SaaS infrastructure (500b). The migration process in the SaaS infrastructure can leverage cloud-based resources efficiently, reducing the dependency on on-premises infrastructure and improving overall operational efficiency.

All third-party trademarks, service marks, trade names, or product names appearing in this specification are the property of their respective owners. They are used solely for identification, descriptive, or illustrative purposes to demonstrate interoperability or compatibility with the systems, platforms, or services referenced herein. Such use does not imply any affiliation, endorsement, or relationship between the applicant and the respective trademark owners. All rights in the referenced trademarks are hereby acknowledged.

All copyrighted materials, technical specifications, software code, and intellectual property referenced herein remain the property of their respective copyright holders. Such materials are referenced solely for technical illustration or comparative analysis without implying any license grant, authorization, or relationship between the applicant and respective owners. No copyrighted content has been reproduced or incorporated into this specification.

1. A method (200) for migrating a virtual machine(s) (501a/501b/501c) from a source host (520) to a target environment (530), the method (200) comprising:
extracting (210) data (550) of a selected virtual machine (501a/501b) from the source host (520) wherein the data (550) comprises operating system data;
transferring (220) an extracted data (550a) of the data (550) from the source host (520) to the target environment (530), a transferred data (552a) of the extracted data (550a) is stored in a memory (532) of the target environment (530) as a stored data (203);
provisioning (230) a selected virtual machine (502a) as per the extracted data (550a) in the target environment (530); and
synchronizing (240) the provisioned virtual machine (502a) in the target environment (530) with the stored data (203) to enable the functioning of the provisioned virtual machine (502a) in the target environment (530).

2. The method (200) of claim 1, wherein the extracting (210) comprises an extractor (310) bypassing a hypervisor layer of the source host (520) and directly accessing a virtual disk file of the virtual machine (501a) to extract the data (550) of the operating system (O1) without requiring administrative privileges over the hypervisor or other virtual machines (501b, 501c) on the source host (520).

3. The method (200) of claim 1, wherein the provisioning (230) is performed by a configurator (330) associated with the target environment (530), the configurator (330) sets up a virtual hardware (H1) according to the extracted data (550a) including allocating virtual CPUs (vCPUs), assigning virtual memory (RAM), configuring virtual network adapters (vNICs), and attaching virtual hard disks (VHDs) for the provisioned virtual machine (502a).

4. The method (200a) of claim 1, further comprising step of: transferring (221) the extracted data (550a) from the source host (520) to a buffer memory (534) (staging area) to store therein; and
transferring (222) the stored extracted data (551) in the buffer memory (534) from the buffer memory (534) to the memory (532) of the target environment (530).

5. The method (200a) of claim 4, wherein a SHA-256 checksum is computed for each data block of the extracted data (550a) and recorded in a manifest file stored in the buffer memory (534), and if a network interruption occurs during transferring (221), a migration tool (320) reads the manifest to identify successfully stored blocks and resumes transfer from the last incomplete block.

6. A system (300) for migrating a virtual machine(s) (501a, 501b) from a source host (520) to a target environment (530), comprising:
an extractor (310) associated with the source host (520) for extracting data (550) of a selected virtual machine (501a/501b) from the source host (520), wherein the data (550) is a data of an operating system (O1/O2) of the virtual machine (501a or 501b);
a migration tool (320) associated with the source host (520) for transferring an extracted data (550a) of the data (550) from the source host (520) to the target environment (530), wherein a transferred data (552a) of the extracted data (550a) is stored in a memory (532) of the target environment (530) as a stored data (203);
a configurator (330) associated with the target environment (530) for provisioning a selected virtual machine (502a) according to the extracted data (550a) in the target environment (530); and
a synchronizer (340) associated with the target environment (530) for synchronizing the provisioned virtual machine (502a) in the target environment (530) with the stored data (203) to enable the functioning of the provisioned virtual machine (502a) in the target environment (530).

7. The system (300) of claim 6, wherein the source host (520) is an on-premises computing environment (520a) or cloud environment (523b) or a cloud platform; and the target environment (530) is a cloud environment or a cloud platform.

8. The system (300) of claim 6, wherein the migration tool (320) transfers the extracted data (550a) from the source host (520) to the target environment (530) as a structured data package over standard network transfer protocols without performing hypervisor-level virtual machine migration.

9. The system (300) of claim 6, wherein the synchronizer (340) divides the stored data (203) and a virtual disk of the provisioned virtual machine (502a) into fixed-size blocks of 4 MB each, computes a SHA-256 hash for each corresponding block pair, copies differing blocks from the stored data (203) to the provisioned virtual machine's (502a) disk, and performs a full-disk checksum validation to confirm the provisioned virtual machine's (502a) disk is an exact replica of the stored data (203).

10. The system (300) of claim 9, wherein if any block fails the full-disk checksum validation, the synchronizer (340) re-copies only the failed blocks and repeats validation up to a configurable retry limit, after which the synchronizer (340) reports failure to a user interface (U1).

11. The system (300) of claim 7, wherein the extractor (310) accesses a virtual disk file of the virtual machine (501a) through a storage API of the cloud environment (523b) when the source host (520) is the cloud environment (523b), and proceeds with the same OS-level extraction as performed for the on-premises computing environment (520a).

12. The system (300a) of claim 6, wherein the system (300a) comprises a buffer memory (534) to store the extracted data (550a) from the source host (520) therein before transferring to the memory (532) of the target environment (530).

13. The system (300a) of claim 12, wherein a SHA-256 checksum is computed for each data block of the extracted data (550a) and recorded in a manifest file stored in the buffer memory (534), and the buffer memory (534) validates the stored extracted data (551) against the manifest before transferring to the memory (532) of the target environment (530).

14. The system (300b) of claim 6, wherein the extractor (310b), the migration tool (320b), the configurator (330b), the synchronizer (340b) are SaaS applications, the source host (520b) and the target environment (530b) connected to a SaaS infrastructure.

15. The system (300) of claim 6, wherein the configurator (330) provisions the selected virtual machine (502a) by setting up a virtual hardware (H1) according to the extracted data (550a) including allocating virtual CPUs (vCPUs), assigning virtual memory (RAM), configuring virtual network adapters (vNICs), and attaching virtual hard disks (VHDs) or virtual machine disk files (VMDKs) for the provisioned virtual machine (502a).

16. The system (300) of claim 6, wherein the synchronizer (340) performs a delta synchronization operation where only changes made to the provisioned virtual machine's (502a) data since a last synchronization are replicated to the target environment (530), ensuring the provisioned virtual machine (502a) remains up to date with minimal data transfer.

17. The system (300) of claim 6, wherein the modules (310, 320, 330, 340) are configured separately in selected memories of the source host (520) and the target environment (530).

18. A cloud platform (400) for migrating a virtual machine(s) (501a, 501b) from a source host (520) to a target environment (530), comprising:
an extractor (410) associated with the source host (520) for extracting data (550) of the selected virtual machine (501a, 501b) from the source host (520), wherein the data (550) is a data of an operating system (O1, O2) of the virtual machine (501a or 501b);
a migration tool (420) associated with the source host (520) for transferring an extracted data (550a) of the data (550) from the source host (520) to the target environment (530), wherein a transferred data (552a) of the extracted data (550a) is stored in a memory (532) of the target environment (530) as a stored data (203);
a configurator (430) associated with the target environment (530) for provisioning a selected virtual machine (502a) according to the extracted data (550a) in the target environment (530); and
a synchronizer (440) associated with the target environment (530) for synchronizing the provisioned virtual machine (502a) in the target environment (530) and the stored data (203) to enable the functioning of the provisioned virtual machine (502a) in the target environment (530).

19. The cloud platform (400) of claim 18, wherein the extractor (410) bypasses a hypervisor layer of the source host (520) and directly accesses a virtual disk file of the virtual machine (501a) to extract the data (550) of the operating system (O1) without requiring administrative privileges over the hypervisor or other virtual machines (501b, 501c) on the source host (520).

20. The cloud platform (400) of claim 18, wherein the cloud platform (400) is accessed by a URL or by activating an application configured in a computing device (460), the computing device (460) is functionally connected to the source host (520) and the target environment (530).
